(19) United States
(12) Patent Application Publication
(10) Pub. No.: US 2007/0254127 A1
(43) Pub. Date: Nov. 1, 2007

(54) Adhesive patch

(75) Inventors: Hsing-Tsung Lin, Shengang Township (TW); Chih-Ming Ou, Shengang Township (TW)

Correspondence Address: EGBERT LAW OFFICES, 412 MAIN STREET, 7TH FLOOR, HOUSTON, TX, 77002, US

(73) Assignee: SUN-GOOD GLUE COMPANY LTD., Shengang Township (TW)

(21) Appl. No.: 11/454,565

(22) Filed: Jun. 19, 2006

(30) Foreign Application Priority Data
Apr. 28, 2006 (TW) 095207271

(51) Int. Cl. B32B 33/00

(52) U.S. Cl. 428/40.1; 428/212

(57) ABSTRACT

The adhesive patch of the present invention can be single layer or double layer. The patch layer is made of TPE, a resin, and a binder, forming an entire patch layer without adhesive pasted over the patch layer to be self-adhesive and elastic. The patch layer has a predetermined length and thickness and defines two side surfaces and a peripheral surface. The adhesive patch of the present invention is self-adhesive, durable, and without residue, so that it can be used widely for anti-spill, anti-slip, earthquake proof, anti-theft, and adhesive properties to improve quality and convenience of products.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an adhesive patch, and more particularly to an invention that is made of TPE, a resin, and a binder, being environment friendly, without residue, and non-active.

### BACKGROUND OF THE INVENTION

There are many different types of adhesive patches in the market today, such as regular tape, double-sided tape, and easy-peel tape. In terms of adhesives used in conventional tapes, the conventional tape has the problem of not being reusable, meaning that once the tape is used, the tape cannot be used again. Therefore, the conventional tape is limited as to where the tape can be used. Even though there is inert adhesive that is widely used on notepads and this inert adhesive is reusable, this inert adhesive is attached to a notepad. Once the notepad is used, the inert adhesive is useless, which is very wasteful.

Moreover, all the adhesive tape used today is “reactive”, which means its structure and adhesiveness is obtained through some chemical reaction. After the reaction is made, the remainder of materials cannot be recycled. Thus, this tape is quite a waste for the industry, and too much of waste causes serious environmental problems.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The adhesive patch of the present invention provides a thermal bonding structure that is non-reactive. The adhesive patch is made of TPE, a resin, and a binder to form a structure that is one piece and self-adhesive. The structure of the adhesive is made after the ingredients mentioned above are mixed without chemical reaction. For the industry, the leftover waste during production of the adhesive patch can be recycled, being heated up and restored to a liquid state before being made into a new product. The adhesive effect is not changed; therefore, the waste can almost be reused completely, greatly reducing the waste of resources and becoming more environmental friendly.

The adhesive patch of the present invention is mixed with TPE, a resin, and a binder; therefore, its entire structure is self-adhesive and leaves no residue. Before the ingredients change quality, the ingredients can be reused for an unlimited number of times. Even when the surface reduces its adhesive capacity because it is covered with dust, the surface may be washed to restore its adhesive capacity. This advantages make the adhesive patch of the present invention to be applied widely on the products that are supposed to be anti-spill, anti-slip, earthquake proof, anti-theft, and adhesive.

### BRIEF DESCRIPTION OF THE SEVERAL VIEWS OF THE DRAWINGS

FIG. 1 shows a perspective view of the preferred embodiment of the present invention.

FIG. 2 shows a sectional view of the preferred embodiment of the present invention.

FIG. 3 shows a sectional view of another preferred embodiment of the present invention.

FIG. 4 shows a sectional view of another embodiment of the present invention.

FIGS. 5-10 show perspective views of the applied embodiments of the present invention.

FIG. 11 shows a perspective view of an object placed on the patch layer shown in FIG. 10.

FIGS. 12-14 show perspective views of the applied embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

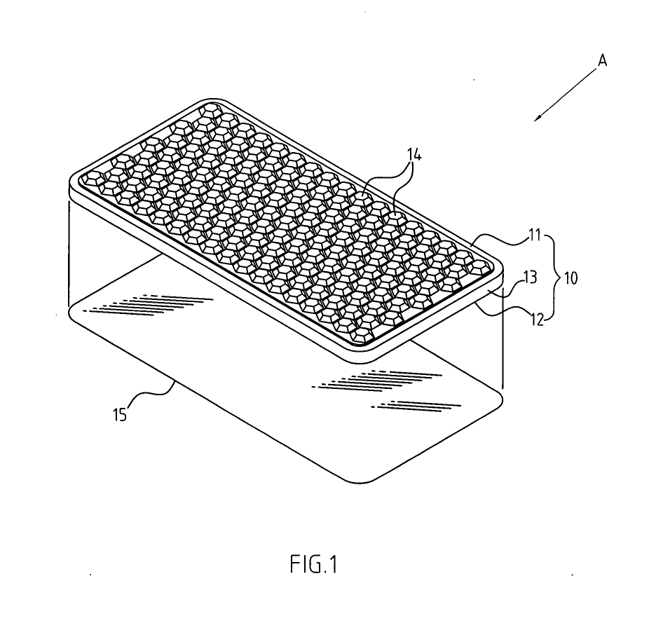

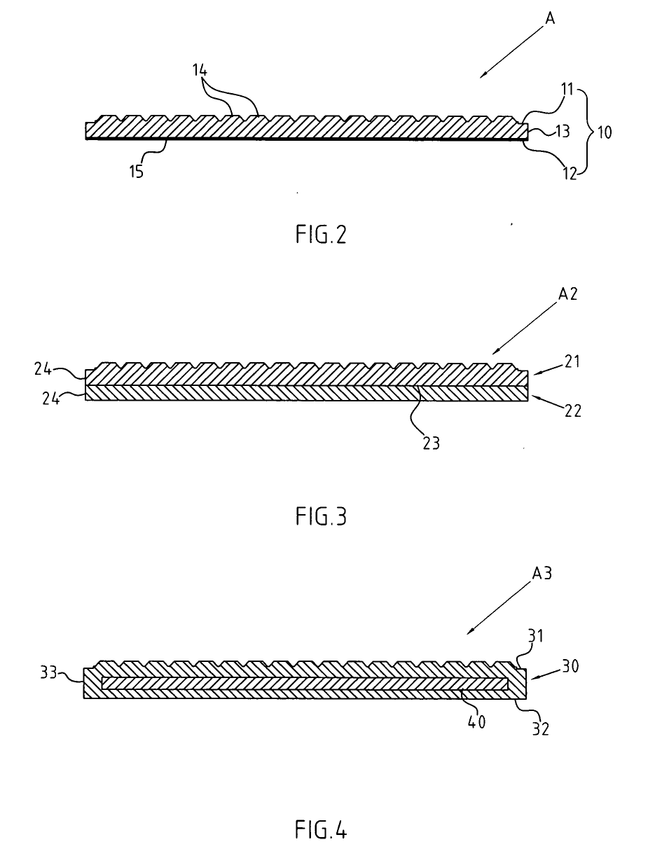

As shown in FIGS. 1, 2, there is a preferred embodiment of a structure of adhesive patch A.

A patch layer 10 is made of TPE, a resin, and a binder, making an entire patch layer 10 without adhesive pasted over the patch to be self-adhesive and elastic. The patch has a predetermined length and thickness, and the patch has two side surface 11, 12 and a peripheral surface 13.

As shown in FIGS. 1 and 2, at least one side surface 11 12 of the patch layer 10 mentioned herein can have a rough surface. The present embodiment has several anti-slip protruding edges 14, which can be anti-slip concaving edges, placed on one side surface 11 of the patch. The present invention can use the rough surface formed by anti-slip protruding edges 14, so as to reduce the surface area of the side surface 11 of the patch layer 10 and the target, so that the single patch A creates different adhesive capacity on both sides.

In this embodiment with a bottom side surface, at least one side 12 of the patch layer 10 has a removable paper 15. The removable paper 15 can be peeled off the surface 12 of the patch layer 10. The removable paper 15 can cover its surface 12 to keep the dust off before being used.

The adhesive patch layer can also be a double-layered structure, as shown in FIG. 3, including a first layer 21 and a second layer 22. The first and second layers 21 22 mentioned herein are made of TPE, a resin, and a binder, making an entire patch layer without having to paste the adhesive over the patch layer to be self-adhesive and elastic. The first and second layers 21 22 have corresponding sides 23 to make it into one piece. The adhesive patch has a predetermined length and thickness, and the adhesive patch defines two side surfaces and a peripheral surface. The adhesive capacity of the second layer 22 is different than the first layer 21 mentioned above. By so doing, it makes the adhesive capacity of the second layer 22 of the lower layer stronger than the first layer 21 at the upper layer. The purpose of the embodiment is to use the second layer 22 that has stronger adhesive capacity for longer lasting effect, using the first layer 21 with weaker adhesive capacity for repeated use.

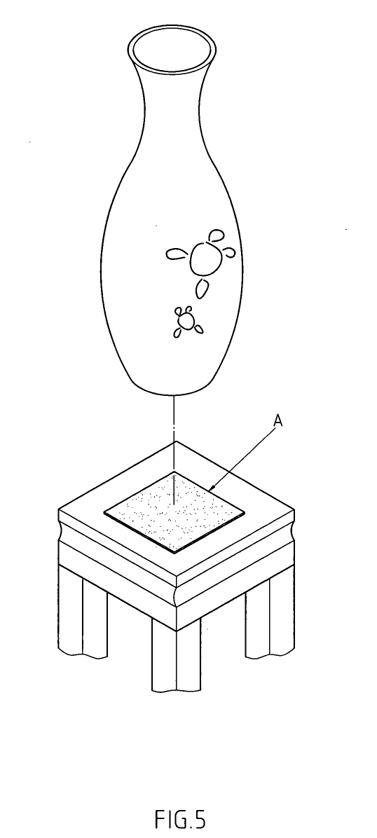

As shown in FIG. 4, there is another preferred embodiment of the adhesive patch layer of the present invention. A patch layer A3 includes a layer 30 that is made of TPE, a resin, and a binder to make an entire patch layer 10 without having to paste the adhesive over the patch to be self-adhesive and elastic. The patch has a predetermined length and thickness, and the patch defines two side surfaces and a peripheral surface. The primary feature of the embodiment is to have at least one hard layer 40 between two sides surfaces 31 32 of the patch layer 10. The hard layer 40 can be made from hard material, such as metal and plastic. The hard layer 40 makes the structure of the patch layer 30 stronger, meeting diversified demands of users.

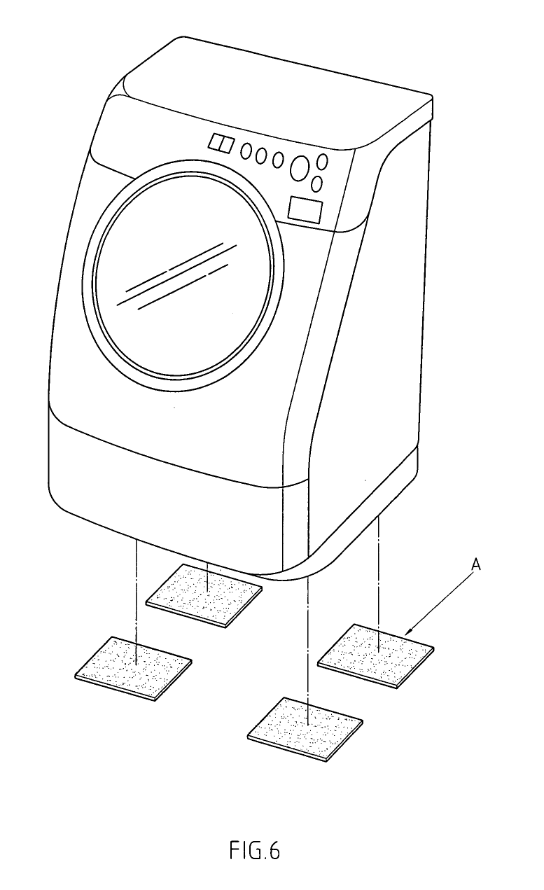

As shown in FIG. 5, one application of the present invention is shown. The adhesive patch can be the lining for some precious object, such as porcelain, using the adhesive of the patch to keep the object from tilting over. Because the patch is not sticky and easy to peel off, the object will not be damaged.

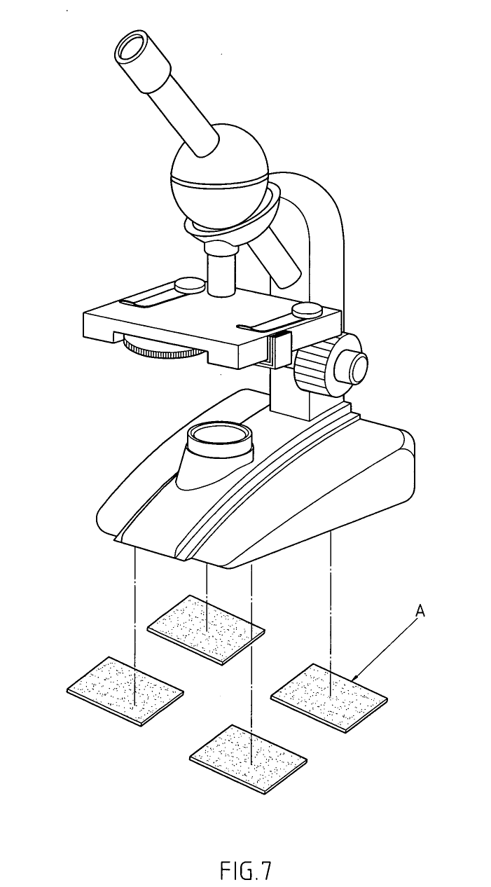

As shown in FIG. 6, a second application of the present invention is shown. The adhesive patch can be the lining for some electronic appliance, such as a washer or dryer, using the adhesive of the patch to make the appliance sound proof, earthquake proof and stable.

As shown in FIG. 7, there is the third application for the present invention. The adhesive patch can be lining for a precision instrument, such as a microscope, using the adhesive of the patch to make the instrument earthquake proof and stable.

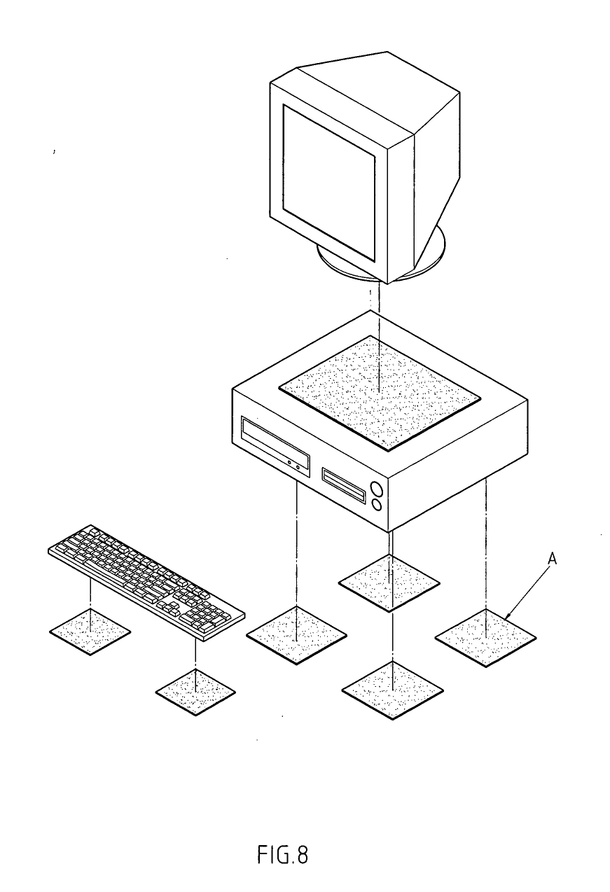

As shown in FIG. 8, there is the fourth application for the present invention. The adhesive patch can be lining for computer equipment, such as a computer main frame, screen and keyboard. The adhesive of the patch A is used to make the equipment sound proof, earthquake proof and stable.

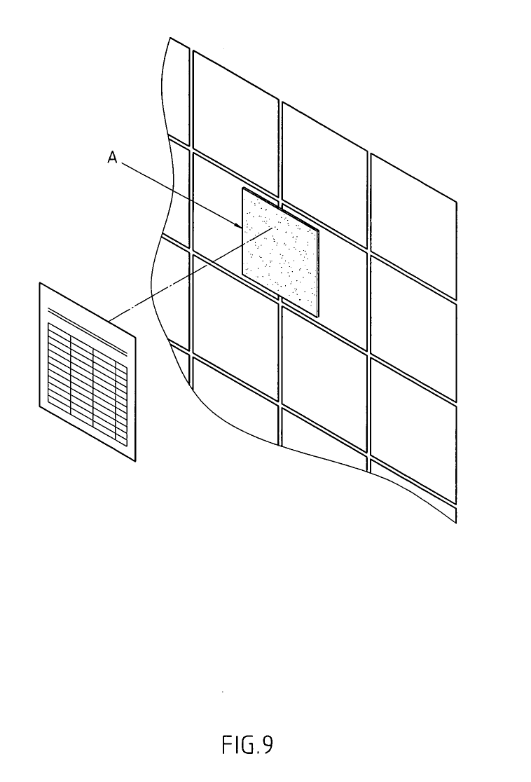

As shown in FIG. 9, there is the fifth application of the present invention. The patch A can be an adhesive medium, the patch being made into a predetermined shape to stick to a wall. The adhesive of the patch A is used for posting papers, which is convenient.

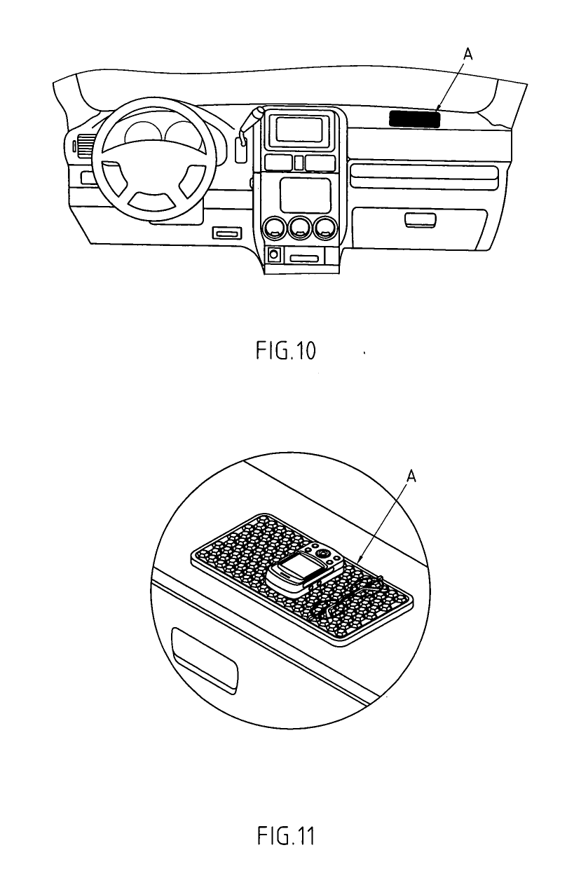

As shown in FIG. 10, the sixth application of the present invention is shown. The adhesive patch A can be used for anti-slip properties. The patch can be made into a predetermined shape to be placed on the dash of the car, using the adhesive of the patch for some objects to be placed thereon (see FIG. 11). The patch keeps the object from slipping, rolling and moving.

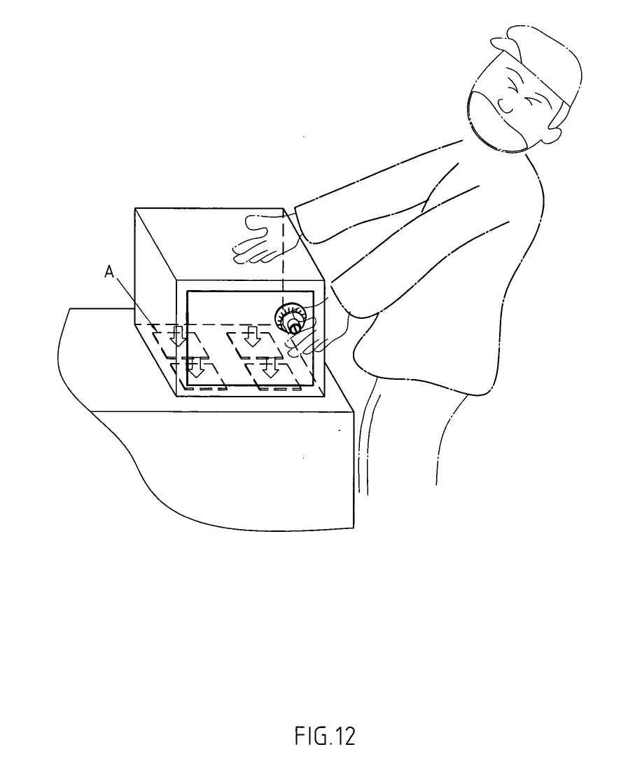

As shown in FIG. 12, the seventh application of the present invention is shown. The patch A can create certain levels of anti-theft protection. As shown in FIG. 12, the patch is placed as the lining on the bottom of a safe, using the adhesive of the patch to keep the thief from carrying the safe easily.

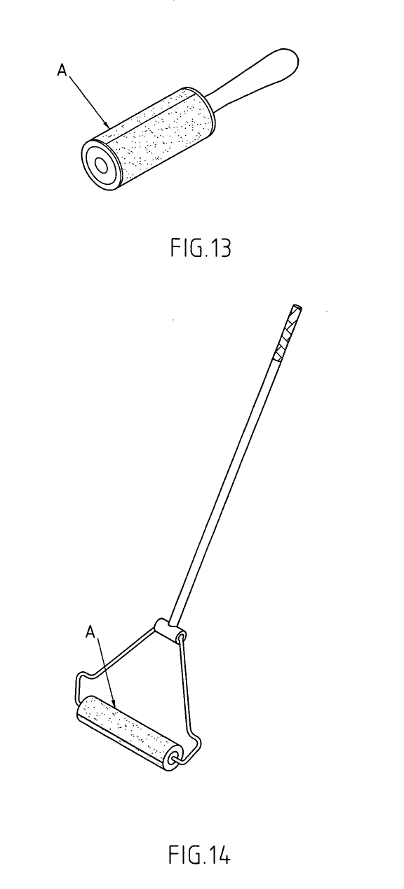

As shown in FIG. 13, there is the eighth application of the present invention. The patch A can be used for handheld products with adhesive handles. The adhesive of the patch A can be reused after washing the surface, makes the invention more environmental friendly.

As shown in FIG. 14, the ninth application of the present invention is shown. The patch A can be used on the mop-type adhesive product. The adhesive of the patch A can be reused after washing the surface, making the invention more environmental friendly than the conventional disposable adhesive product.

The patch disclosed in the present invention has at least two layers, using the different adhesives of two kinds, the layer with stronger adhesive capacity for long term use and the layer with weaker adhesive capacity for reusable purposes.

The surface of the patch layer mentioned herein can have a rough surface. The rough surface is formed by anti-slip protruding edges, so as to reduce the surface area of the side surface of the patch layer and the target, so that the single patch creates different adhesive capacity on both sides.

The adhesive patch of the present invention can also include at least a hard layer, so that the patch layer has the preferred hardness to meet the demand of the users.

Although the invention has been explained in relation to its preferred embodiment, it is to be understood that many other possible modifications and variations can be made without departing from the spirit and scope of the invention as hereinafter claimed.

We claim:

1. An adhesive patch comprising:
a first layer, being comprised of TPE, a resin, and a binder, forming an entire patch layer without adhesive pasted over said first layer to be self-adhesive and elastic, said first layer having a predetermined length and thickness and defining two side surfaces and a peripheral surface; and
a second layer, being attached to one side of said first layer, said second layer being comprised of TPE, a resin, and a binder to form an entire patch layer without adhesive pasted over said second layer to be self-adhesive and elastic, said second layer having a predetermined length and thickness and defining two side surfaces and a peripheral surface, adhesiveness of said second layer being different than said first layer.

2. The adhesive patch defined in claim 1, wherein said first layer and said second layer are heat resistant, non-toxic, non-odor, recyclable, and reusable without peel-off, leaving no residue.

3. The adhesive patch defined in claim 1, wherein said first layer and said second layer form at least an external side surface with an anti-slip protruding edge or anti-slip concaving edge.

4. The adhesive patch defined in claim 1, further comprising:
a removable paper placed on at least one side surface of said first layer or said second layer, said removable paper being able to be peeled.

5. An adhesive patch comprising:
a patch layer, being comprised of TPE, a resin, and a binder, forming an entire patch layer without adhesive pasted over said patch layer to be self-adhesive and elastic, said patch layer having a predetermined length and thickness and defining two side surfaces and a peripheral surface; and
at least a hard layer placed between the two side surfaces.

6. The adhesive patch defined in claim 5, wherein said patch layer is heat resistant, non-toxic, non-odor, recyclable, and reusable without peel-off, leaving no residue.

7. The adhesive patch defined in claim 5, wherein said patch layer forms at least an external side surface having an anti-slip protruding edge or anti-slip concaving edge.

8. The adhesive patch defined in claim 5, further comprising:
a removable paper being placed on at least one side surface of said patch layer, said removable paper being able to be peeled off.

9. An adhesive patch comprising:
a patch layer, being comprised of TPE, a resin, and a binder, forming an entire patch layer without adhesive pasted over said patch layer to be self-adhesive and elastic, said patch layer having a predetermined length and thickness and defining two side surfaces and a peripheral surface; and
at least a removable paper, being placed on one side surface of said patch layer and being able to be peeled off the side surface of said patch layer.

10. The adhesive patch defined in claim 9, wherein said patch layer is heat resistant, non-toxic, non-odor, recyclable, and reusable without peel-off, leaving no residue.

11. The adhesive patch defined in claim 9, said patch layer forming at least an external side surface having an anti-slip protruding edge or anti-slip concaving edge.
